(19) United States
(12) Patent Application Publication
(10) Pub. No.: US 2005/0034154 A1
(43) Pub. Date: Feb. 10, 2005

(54) User interface for a video display device

(76) Inventors: Sabrina Tai-Chen Yeh, Laguna Beach, CA (US); Michael Donald McDermott, Chula Vista, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/727,304

(22) Filed: Dec. 2, 2003

Related U.S. Application Data
(60) Provisional application No. 60/493,995, filed on Aug. 8, 2003.

(51) Int. Cl. G06F 3/00; H04N 5/445; G06F 13/00

(52) U.S. Cl. 725/38

(57) ABSTRACT

An audiovisual device in communication with at least one recording device includes a user input device and a user interface displayed on the audiovisual device. The user interface includes a first window associated with a source of audiovisual programming and a second window associated with the recording device.

### RELATED APPLICATIONS

The present application claims priority under 35 U.S.C. § 119(e) from previously-filed U.S. Provisional Patent Application No. 60/493,995, filed Aug. 8, 2003 and entitled “I-Link Device Graphical User Interface for TV,” which is incorporated herein by reference in its entirety.

### BACKGROUND

The Institute of Electrical and Electronics Engineers (IEEE) Standard 1394, for a High Performance Serial Bus, is an electronics standard that describes a serial bus or pathway for transmitting digital data between connected devices. Any digital data can be transmitted including, for example, computer data and audio or audiovisual programming. Consequently, an IEEE 1394 pathway is often used to connect peripheral devices to a personal computer or to connect components of an audiovisual or entertainment system.

IEEE 1394 provides a single plug-and-socket connection on which up to 63 devices can be attached with data transfer speeds up to 400 Mbps (megabits per second). Many peripheral devices, and audiovisual and entertainment system components now come equipped to use an IEEE 1394 pathway. Two popular implementations of IEEE 1394 are the i.LINK® made by Sony Corp. of Tokyo, Japan and the FireWire® made by Apple Computer, Inc. of California.

### SUMMARY

A user interface for a video display device that is connected to at least one recording device and at least one source of audiovisual programming includes a first window associated with a source of audiovisual programming; and a second window associated with a connected recording device. The first window displays the audiovisual programming from the source of audiovisual programming or an electronic program guide for the source of audiovisual programming.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates one embodiment of an audiovisual system according to the technology described herein.

FIG. 2 illustrates a user interface for the system of FIG. 1.

FIG. 3 illustrates another embodiment of an audiovisual system using the user interface of FIG. 2.

FIG. 4 illustrates another embodiment of an audiovisual system using the user interface of FIG. 2.

FIG. 5 illustrates another embodiment of an audiovisual system using the user interface of FIG. 2.

FIG. 6 is a flowchart illustrating one method for operating the user interface of FIG. 2.

FIG. 7 is a flowchart illustrating another method for operating the user interface of FIG. 2.

Throughout the drawings, identical reference numbers designate similar, but not necessarily identical, elements.

### DETAILED DESCRIPTION

In an audiovisual or entertainment system, the center of the system is typically a television set, frequently a digital television set, with a variety of components that can provide audiovisual programming signals to the television. The television set can then be used to display the audiovisual programming for a viewer.

As used herein and in the appended claims, the term “television set” will be understood to refer broadly to any video monitor or display device capable of displaying still or motion pictures. The term “audiovisual device” will be understood to refer broadly to any device that processes video and/or audio data including, but not limited to, television sets, computers, camcorders, set-top boxes, Personal Video Recorders (PVRs), video cassette recorders, digital cameras and the like. The term “audiovisual programming” will refer to any programming that can be displayed and viewed on a television set or other display device, including motion or still pictures with or without an accompanying audio soundtrack. “Audiovisual programming” will also be defined to include audio programming with no accompanying video that can be played for a listener using a sound system of the television set or entertainment system. Audiovisual programming can be in any of several forms including, data recorded on a recording medium, an electronic signal being transmitted to or between system components or content being displayed on a television set or other display device.

Many or all of the components of an entertainment system may include an IEEE 1394 interface for connection to one or more of the other system components. The advantages of an IEEE 1394 connection include, a simple common plug-in serial connector on compliant devices, a thin serial cable rather than a thicker parallel cable, a very high-speed rate of data transfer that will accommodate multimedia applications and hot-plug and “Plug and Play” capabilities. IEEE 1394 also offers the ability to chain devices together in a number of different ways without complicated set-up requirements.

IEEE 1394 provides two types of data transfer: asynchronous and isochronous. Asynchronous is for traditional load-and-store applications where data transfer can be initiated and an application interrupted as a given length of data arrives in a buffer. Isochronous data transfer ensures that data flows at a pre-set rate so that an application or recipient device can handle the incoming data in a timed way. For audiovisual programming, isochronous data transfer reduces the need for buffering and helps ensure a continuous presentation for the viewer.

Some products that do or could use an IEEE 1394 interface include digital cameras, digital video disk (DVD) players, digital video tape players, digital camcorders, digital video recorders, digital set-top boxes, digital television sets and music systems. Future products, such as home audiovisual servers, and other digital products of the future are expected to use the IEEE 1394 interface. Because an IEEE 1394 interface is a peer-to-peer interface, one device can send data directly to another. For example, a camcorder can use an IEEE 1394 interface to send video data directly to a computer or digital video recorder for dubbing, or to a digital television set for display.

One or more of the components connected to an entertainment system are likely to be able to record audiovisual programming for future viewing. Examples of such components include video cassette recorders (VCRs), camcorders and digital or personal video recorders (PVRs). PVRs typically include a hard drive on which a large volume of audiovisual programming can be digitally stored. Sometimes, the PVR is incorporated into a set-top box that also allows receipt of audiovisual programming on a subscription basis from a cable or satellite television system.

With an IEEE 1394 connection in place, it is very easy to transfer audiovisual programming among the various components of the entertainment system for display or for recording. In some instances, one component may also be able to send control signals to control the operation of another component. For example, the television set may be able to control the operation of a recording device that is recording the audiovisual programming being displayed on the television set. However, controlling other components through a main component can lead to some confusion on the part of the user who may have difficulty determining what audiovisual programming is being recorded and with what recording device.

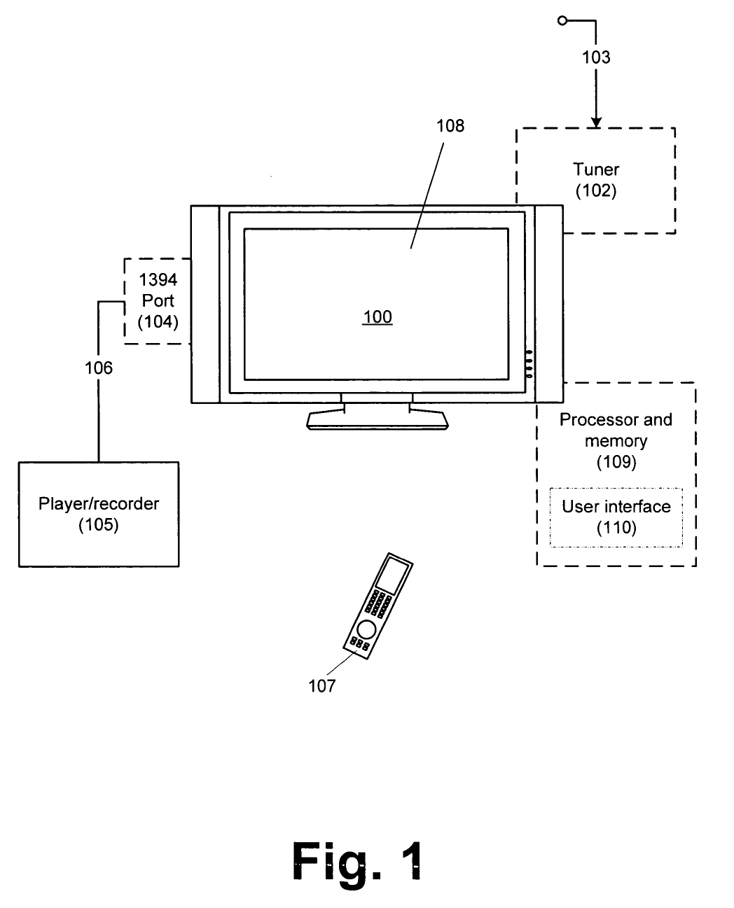

FIG. 1 illustrates an audiovisual or entertainment system according to an embodiment of the technology described herein. As shown in FIG. 1, a digital television set (100) or other audiovisual device provides the display of audiovisual programming. For example, the digital television set (100) may be connected to a cable or satellite television system (103) to receive audiovisual programming. Additionally, the digital television set (100) may receive terrestrial broadcasts of audiovisual programming using an antenna. The digital television set (100) may also be connected to the Internet or other computer network to receive audiovisual programming.

If the digital television set (100) receives a signal that includes multiple channels of audiovisual programming, a tuner (102) is used to select a particular audiovisual program from among the channels of programming available. The tuner (102) may be incorporated into the digital television set (100) or may be in a set-top box connected to the television set (100).

In the system illustrated in FIG. 1, the television set (100) also includes an IEEE 1394 port (104) so that the television set (100) can be connected to another system component using an IEEE 1394 pathway (106). For example, this other component may be a player/recorder (105) such as a digital video recorder, a PVR, a personal computer, a camcorder, a VCR or the like. Alternatively, both the television set (100) and the player/recorder (105) may be connected to a receiver or digital audiovisual center and communicate through that digital audiovisual center.

In this system, audiovisual programming received from the tuner (102) can be displayed on the screen (108) of the television set (100) and/or transmitted to the player/recorder (105) to be recorded. The stored audiovisual programming can then also be sent from the player/recorder (105) to the television set (100) for display.

The television set (100) may be controlled by a user input device. The user input device may be buttons, a keypad, a keyboard or other controls on the television set (100) itself. Additionally, the user input device may be, or include, a remote control unit (107) that wirelessly transmits commands to the television set (100).

In the system illustrated in FIG. 1, the television set (100) can also send control commands to the player/recorder (105) to cause the player/recorder (105) to, for example, record or transmit audiovisual programming. These commands to the player/recorder (105) may be made on the remote control unit (107) by a viewer and are then transmitted to the television (100) and then to the player/recorder (105) via the IEEE 1394 pathway (106).

However, controlling the player/recorder (105) through the television set (100) can lead to some confusion on the part of the user. In particular, if multiple player/recorders or other recording devices are connected to the system, the user may have some difficulty determining what audiovisual programming is being recorded and with what recording device.

Accordingly, the television set (100) incorporates a user interface (110) that is designed to assist the user in controlling connected devices, managing audiovisual signal sources and recording desired audiovisual programming. The user interface (110) may be stored in and executed by a processor and memory unit (109) of the television set (100).

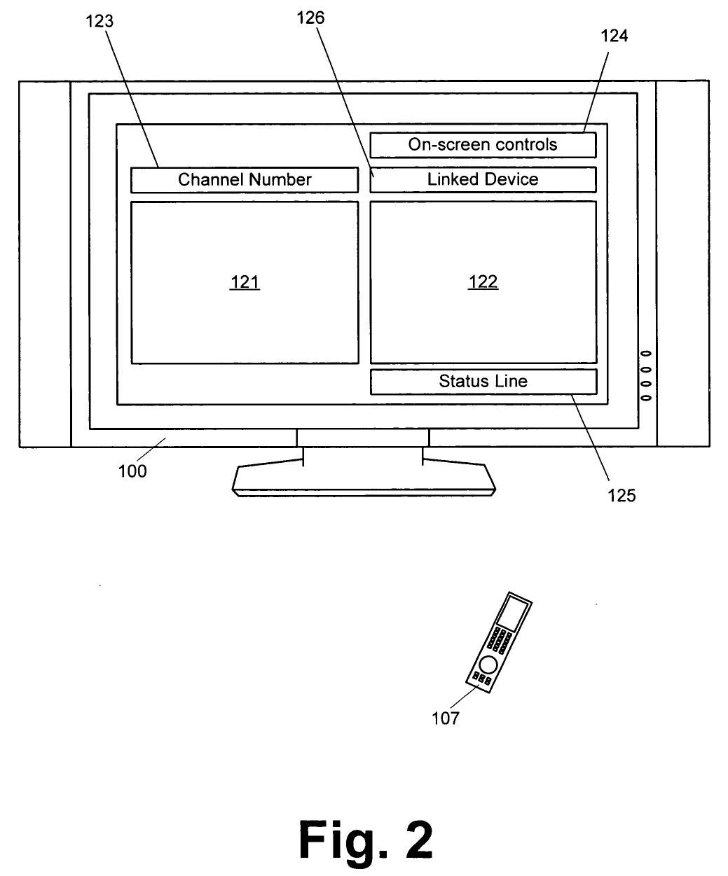

FIG. 2 illustrates a possible appearance of the graphical user interface (110) for the television set and entertainment system illustrated in FIG. 1. This user interface is displayed on the screen (108, FIG. 1) of the television set (100) and, as indicated, helps the user better control and determine what audiovisual programming is being recorded and with what recording device.

In the example shown in FIG. 2, the user interface includes two windows (121 and 122). A separate stream of audiovisual programming can be displayed in each of the two windows. For example, the audiovisual programming received from the tuner (102, FIG. 1) may be displayed in the left window (121). The channel number (123) or other identifier for the audiovisual programming displayed in the left window (121) may be displayed in association with the left window (121).

The right window (122) represents a particular device, such as the player/recorder (105) or other recording device, that is linked to the television set (100) or entertainment system with, for example, an IEEE 1394 pathway (106, FIG. 1). If there are multiple linked devices connected to the television set (100), the user may select which of the linked devices is represented by the right window (122) using the on-screen controls (124) associated with the right window (122). An identifier (126) of the linked device being actively represented by the right window (122) can be displayed in association with the right window (122).

The on-screen controls (124) include controls that can be selected and operated using, for example, the remote control unit (107), to send control commands to the linked device then being represented by the right window (122). Accordingly, the available on-screen controls (124) may change with each selection of a new linked device being represented. The on-screen controls (124) may include, for example, controls for such commands as “play,” “record,” “back,” “forward,” “stop,” “pause,” etc.

If the linked device is outputting audiovisual programming to the television set (100), that audiovisual programming can be displayed in the right window (122). Thus, the user can readily see what audiovisual programming is coming from the tuner (102, FIG. 1) in the left window (121) and what audiovisual programming is coming from a linked device (e.g., 105, FIG. 1) in the right window (122).

If the user desires to record the audiovisual programming of the left window (121) with the recording device being represented by the right window (122), the user can input a record command using the on-screen controls (124). The recording device designated by the identifier (126) will then begin recording the audiovisual programming from the tuner (102, FIG. 1). The “recording” status of the linked device may be indicated by a status identifier (125) that is displayed in association with the right window (122). The status identifier (125) indicates the current operation being performed by the linked device, e.g., “recording,” “play,” “forward,” “back,” “pause,” “stop,” etc. The right window (122) may also display the same audiovisual programming being displayed in the left window (121) to further indicate that the linked device represented by right window (122) is recording the audiovisual programming being shown in the left window (121).

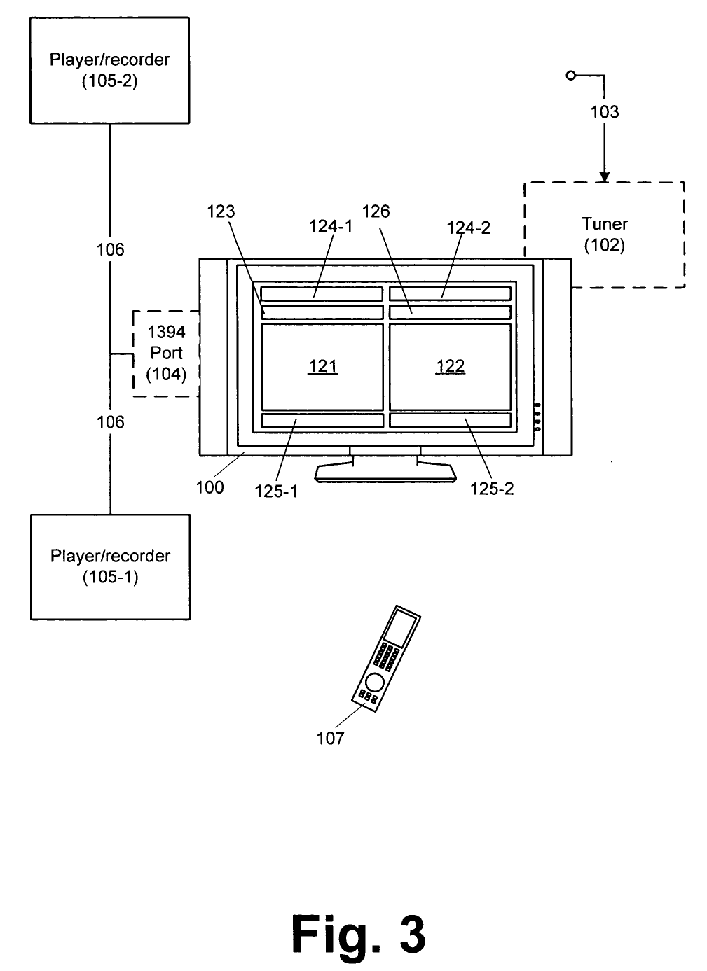

FIG. 3 illustrates another embodiment of an entertainment system and another use for the user interface described above. As shown in FIG. 3, and as mentioned above, multiple player/recorder devices (105-1, 105-2) may be connected to the television set (100). Consequently, the right side of the user interface may be selectively used to represent any of the linked devices (105-1, 105-2) so that that device can be controlled to record the audiovisual signal from, for example, the tuner (102, FIG. 1).

Alternatively, the user interface can be used to control audiovisual programming originating from one linked device (e.g., 105-1) and being routed to a second linked device (e.g., 105-2). For example, using on-screen controls (124-1) and the remote control unit (107), the left side of the interface can be used to select, represent and control a first linked device (105-1). Consequently, audiovisual programming being received from that first linked device (105-1) is displayed in the left window (121) and an identifier (123) of the first linked device will be displayed in association with the left window (121).

Again, using on-screen controls (124-2), the right side of the interface can be used to select, represent and control a second linked device (105-2). Consequently, audiovisual programming being received from that second linked device (105-1), if any, is displayed in the right window (122) and an identifier (126) of the second linked device will be displayed in association with the right window (122).

We now assume that the user would like to record the audiovisual programming being received from the first linked device (105-1) on the second linked device (105-2). Consequently, the user, with the remote control unit (107), may operate the on-screen controls (124-2) for the second linked device (105-2) to cause the second linked device (105-2) to begin recording the audiovisual programming from the first linked device (105-1). As before, a “recording” status may be display in a status indicator (125-2) for the second linked device (105-2). Similarly, a “play” status may be displayed in a status indicator (125-1) for the first linked device (105-1).

In this example, although there may be other audiovisual inputs to the system, a command to “record” will be interpreted and implemented as a command to record the audiovisual programming being displayed in the other window (121 or 122). For example, a “record” command entered through the right on-screen controls (124-2) would be interpreted as a command to record the audiovisual programming being displayed in the left window (121) on the device represented by the right on-screen controls (124-2) and vice versa. Thus, it becomes much easier for a user to determine and control what is being recorded and with what recording device.

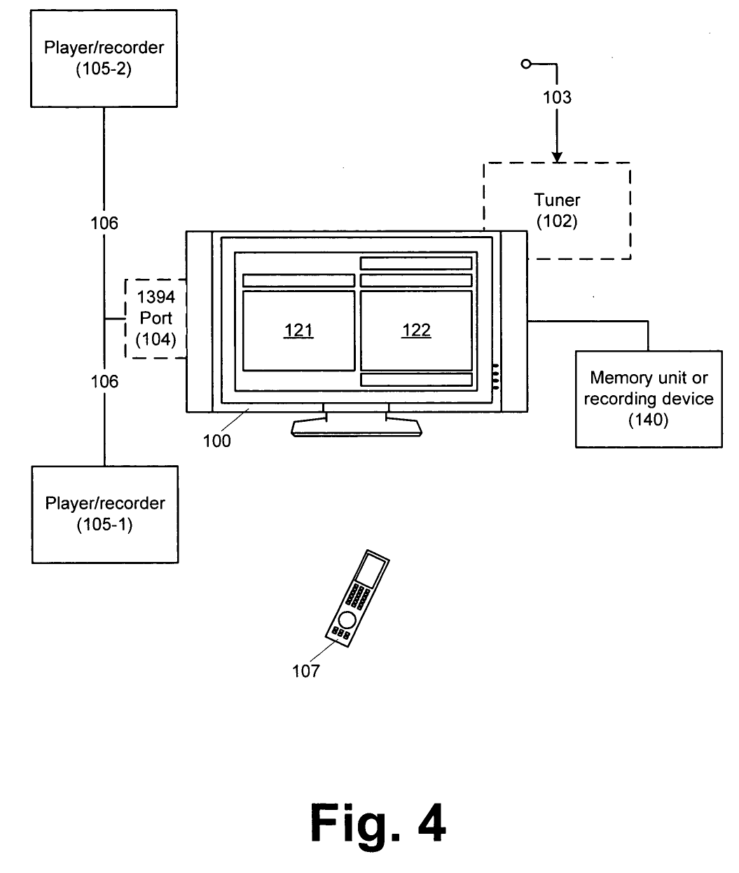

FIG. 4 illustrates another embodiment of an entertainment system and another use for the user interface described herein. As shown in FIG. 4, the television set (100) may incorporate or be connected to a memory unit or recording device (140) that is capable of storing audiovisual programming. This device (140) may be, for example, a recording device that is connected to the system using something other than an IEEE 1394 pathway. The device (140) may include a digital memory card, such as a Sony Memory Stick@.

As illustrated in FIG. 4, the user interface can also be used to select the recording device (140) to receive and record audiovisual programming. In such a case, the recording device (140) may be among the devices that can be selected for representation by the right or left side of the interface.

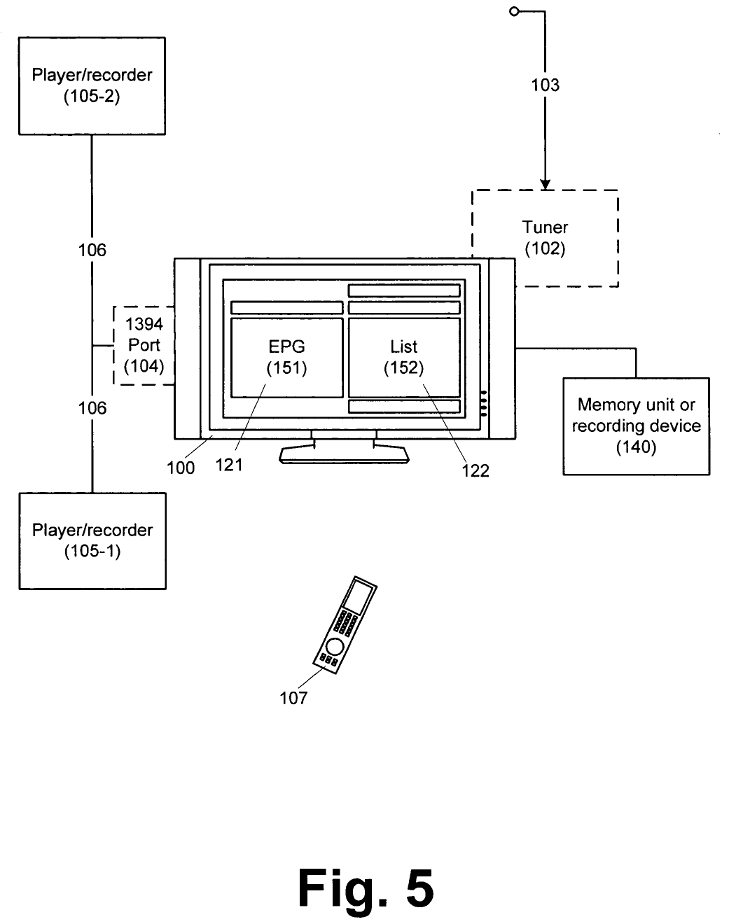

FIG. 5 illustrates another embodiment of an entertainment system and another use for the user interface described herein. As shown in FIG. 5, the user interface described herein can be used to set up a timed program for recording audiovisual programming that will be broadcast at a future time. In this example, the television set (100) receives an electronic program guide (EPG) (151) that lists future programming that will be broadcast over; for example, a cable or satellite television system (103), to which the television set (100) is connected.

In the example of FIG. 5, the EPG (151) is displayed in one of the windows of the interface (e.g., left window 121). Using the remote control unit (107) or other controls, the user can the scroll through the EPG (151) to see individual audiovisual programs that will be broadcast to the television set (100).

If the user desired to record one of the listed audiovisual programs, the user can then operate the on-screen controls (124, FIG. 2) to select a particular recording device with which to record the desired program, if more than one recording device is available. The user then selects the desired program in the listing of the EPG (151). Again, this can be done with the remote control unit (107).

The listing for the selected program is then displayed or indicated in the other window (e.g., right window 122) of the user interface. Consequently, the right window (122) now displays a list (152) of the programs selected for recording. This list (152) can be added to by selecting additional programs for recording from the EPG (151). Following this process, at the appropriate times, the incoming signal from the provider system (103) will be routed to the designated recording device and that recording device activated so as to record the programs selected by the user. Because the programs to be recorded are selected from an EPG, the system automatically knows the channel and time of the program without the need for the user to input such details.

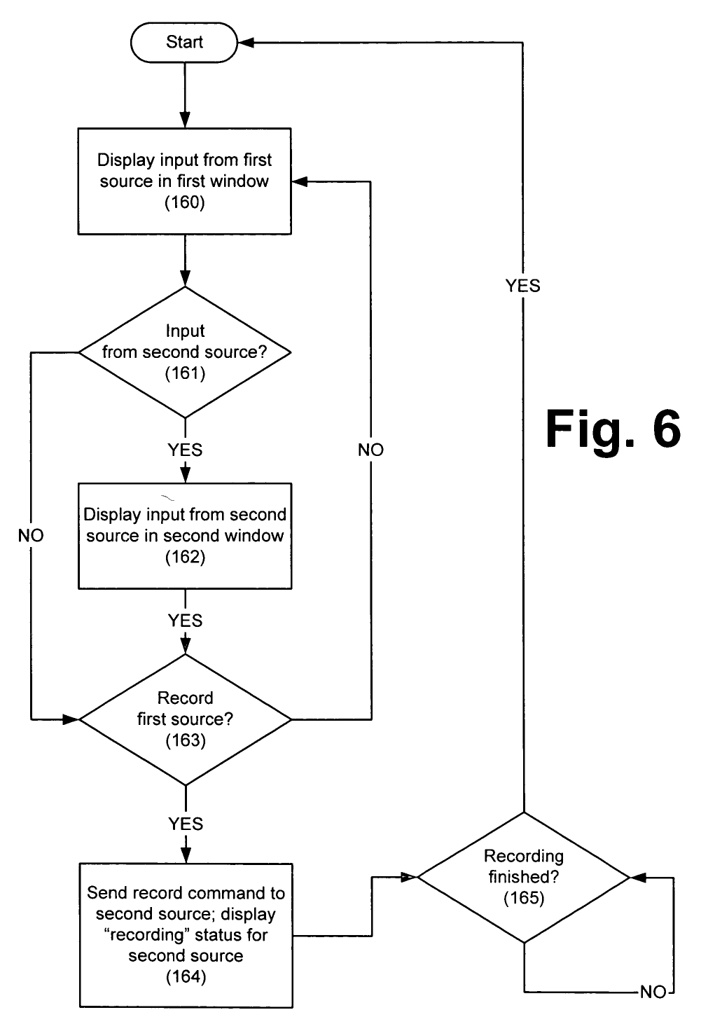

FIG. 6 is a flowchart illustrating one method for operating the user interface of FIG. 2. As shown in FIG. 6, input or audiovisual programming from a first source is displayed (160) in one of the two available windows (e.g., 121, FIG. 2) of the user interface of the television set (100, FIG. 2). This audiovisual programming may be broadcast to the television set, for example, over a cable or satellite system (103, FIG. 1), or may be input to the television set from a player/recorder (105, FIG. 1). The user can operate the user interface to select the source of the audiovisual programming displayed in the first window.

Next, it is determined if audiovisual programming is also being received from a second source (determination 161). The second source considered may be selected by the user's operation of the user interface and may be one of several available additional sources of audiovisual programming. If audiovisual programming is being received from the second source (161), that programming is displayed in the second of the two windows (e.g., 122, FIG. 2).

If the user desires to record the programming received from the first source (determination 163), the user can operate the user interface to send a record command (164) to the second source, i.e., a selected recording device (e.g., player/recorder 105, FIG. 1 or device 140, FIG. 4). The second source then begins recording the audiovisual programming from the first source. A “recording” status indicator may be displayed for the second source (164) in the user interface. This may include a textual indicator as well as displaying the audiovisual programming being recorded in the second window (122) associated with the second source that is doing the recording.

This continues until the recording process is terminated (165). The user can control the second source through the user interface of the television set to terminate further recording using the on-screen controls described above.

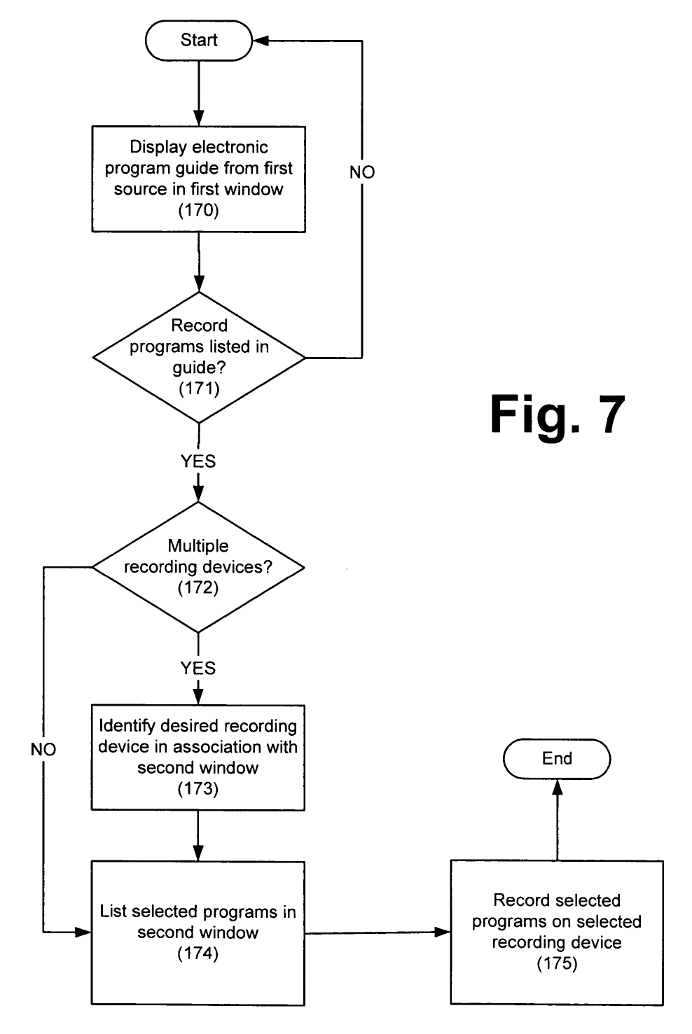

FIG. 7 is a flowchart illustrating another method for operating the user interface of FIG. 2. As shown in FIG. 7, an EPG is displayed (170) in a first window of the user interface (e.g., 121, FIG. 2). As described above, the EPG (151, FIG. 5) may be received from a cable or satellite system and list the programming that will be broadcast by that service provider.

Assuming the user wishes to record some of the programming listed in the EPG (determination 171), it is then determined (determination 172) whether there are multiple devices available that could record the desired programming. The recording devices available may include any of the devices listed herein such as a PVR, VCR, memory card, etc. If there are multiple recording devices available, the user operates the on-screen controls (e.g., 124, FIG. 2) to select (172) the recording device desired.

Next, the user proceeds to select programs from the EPG that are to be recorded. These selections are listed (174) in the second window of the interface (e.g., 122, FIG. 2). The selected programs are then automatically recorded (175) by the system. At the appropriate times, the system will tune the channel of the selected program and record that program with the designated recording device.

The user may use different recording devices during this process. For example, the user may create multiple lists in the second window (122) by successively selecting different recording devices to be represented by the second window (1 22).

The user interface described herein may be embodied as a set of processor-readable instructions stored on a processor-readable medium, such as the memory unit (109, FIG. 1) of a digital television set, a hard drive or computer disk. The flowcharts of FIGS. 6 and 7 provide a functional description of the user interface that allow such processor-readable instructions or code to be readily prepared in any of a variety of device programming languages.

The preceding description has been presented only to illustrate and describe embodiments of the invention. It is not intended to be exhaustive or to limit the invention to any precise form disclosed. Many modifications and variations are possible in light of the above teaching. For example, in some embodiments, the user interface described may be located on a personal computer or other device that communicates with and controls a source of audiovisual programming and/or a recording device. It is intended that the scope of the invention be defined by the following claims.

1. A user interface for a television set connected to at least one recording device and at least one source of audiovisual programming, said user interface comprising:
a first window associated with a source of audiovisual programming; and
a second window associated with a connected recording device;
wherein said first window displays said audiovisual programming from said source of audiovisual programming.

2. The user interface of claim 1, wherein said recording device is also a second source of audiovisual programming and said audiovisual programming from said recording device is displayed in said second window.

3. The user interface of claim 1, further comprising controls for controlling said connected recording device.

4. The user interface of claim 3, further comprising a status identifier for identifying a current operation being performed by said connected recording device.

5. The user interface of claim 3, wherein, when said controls are used to send a record command to said connected recording device, said connected recording device automatically records said audiovisual programming being displayed in said first window.

6. The user interface of claim 5, wherein, while said connected recording device is recording, said audiovisual programming is also displayed in said second window.

7. The user interface of claim 3, wherein multiple recording device are connected, said controls further comprising controls for selecting a recording device to be associated with said second window and controlled through said user interface.

8. The user interface of claim 7, further comprising a device identifier for identifying which connected recording device is currently associated with said second window.

9. The user interface of claim 1, further comprising an identifier identifying said source of audiovisual programming, with multiple sources of audiovisual programming being available.

10. The user interface of claim 9, further comprising controls associated with said first window for selecting and controlling said source of audiovisual programming associated with said first window.

11. The user interface of claim 10, further comprising a status identifier identifying a current operation being performed by said source of audiovisual programming.

12. The user interface of claim 1, wherein said at least one recording device is connected to said television set with an IEEE 1394 pathway.

13. The user interface of claim 1, wherein said recording device is a memory card.

14. A user interface for a television set connected to at least one recording device and at least one source of audiovisual programming, said user interface comprising:
a first window associated with a source of audiovisual programming; and
a second window associated with a connected recording device;
wherein said first window displays an electronic program guide for said source of audiovisual programming, and said second window lists programs selected by a user from said electronic program guide.

15. The user interface of claim 14, wherein said connected recording device associated with said second window automatically records said programs selected by a user from said electronic program guide.

16. The user interface of claim 14, wherein multiple recording devices are connected and said user interface comprises controls for selecting which recording device is associated with said second window.

17. The user interface of claim 14, wherein multiple sources of audiovisual programming are connected and said user interface comprises controls for selecting which source of audiovisual programming is associated with said first window.

18. A video display device comprising:
a screen;
a user interface displayed on said screen; and
a connection to at least one recording device and at least one source of audiovisual programming;
wherein said user interface comprises a first window associated with a source of audiovisual programming, and a second window associated with a connected recording device.

19. The video display device of claim 18, wherein said first window displays said audiovisual programming from said source of audiovisual programming.

20. The video display device of claim 18, wherein said connected recording device is also a second source of audiovisual programming and said audiovisual programming from said recording device is displayed in said second window.

21. The video display device of claim 18, further comprising a remote control unit, wherein said user interface further comprises on-screen controls for controlling said connected recording device, said on-screen controls being operated with said remote control unit.

22. The video display device of claim 21, wherein said user interface further comprises a status identifier for identifying a current operation being performed by said connected recording device.

23. The video display device of claim 21, wherein, when said on-screen controls are used to send a record command to said connected recording device, said connected recording device automatically records said audiovisual programming being displayed in said first window.

24. The video display device of claim 23, wherein, while said connected recording device is recording, said audiovisual programming is also displayed in said second window.

25. The video display device of claim 21, wherein multiple recording device are connected, said on-screen controls further comprising controls for selecting a recording device to be associated with said second window and controlled through said user interface.

26. The video display device of claim 25, wherein said user interface further comprises a device identifier for identifying which connected recording device is currently associated with said second window.

27. The video display device of claim 18, wherein said user interface further comprises an identifier identifying said source of audiovisual programming, with multiple sources of audiovisual programming being available.

28. The video display device of claim 27, wherein said user interface further comprises controls associated with said first window for selecting and controlling said source of audiovisual programming associated with said first window.

29. The video display device of claim 28, wherein said user interface further comprises a status identifier identifying a current operation being performed by said source of audiovisual programming.

30. The video display device of claim 18, wherein said connection to at least one recording device is an IEEE 1394 interface.

31. The video display device of claim 18, further comprising a memory card in said video display device, wherein said memory card is said recording device associated with said second window.

32. The video display device of claim 18, wherein said first window displays an electronic program guide for said source of audiovisual programming associated with said first window, and said second window lists programs selected by a user from said electronic program guide.

33. The video display device of claim 32, wherein said connected recording device associated with said second window automatically records said programs selected by a user from said electronic program guide.

34. The video display device of claim 32, wherein multiple recording devices are connected and said user interface comprises controls for selecting which recording device is associated with said second window.

35. The video display device of claim 32, wherein multiple sources of audiovisual programming are connected and said user interface comprises controls for selecting which source of audiovisual programming is associated with said first window.

36. Processor-readable instructions stored on a processor-readable medium, said instructions, when executed, providing an on-screen user interface for a video display device, said user interface comprising:
a first window associated with a source of audiovisual programming connected to said video display device; and
a second window associated with a recording device connected to said video display device.

37. The processor-readable instructions of claim 36, wherein said first window displays said audiovisual programming from said source of audiovisual programming.

38. The processor-readable instructions of claim 36, wherein said connected recording device is also a second source of audiovisual programming and said audiovisual programming from said recording device is displayed in said second window.

39. The processor-readable instructions of claim 36, wherein said user interface further comprises on-screen controls for controlling said connected recording device.

40. The processor-readable instructions of claim 39, wherein said user interface further comprises a status identifier for identifying a current operation being performed by said connected recording device.

41. The processor-readable instructions of claim 39, wherein, when said on-screen controls are used to send a record command to said connected recording device, said user interface causes said connected recording device to record said audiovisual programming being displayed in said first window.

42. The processor-readable instructions of claim 41, wherein, while said connected recording device is recording, said audiovisual programming is also displayed in said second window.

43. The processor-readable instructions of claim 39, wherein when multiple recording device are connected to said video display device, said controls further comprise controls for selecting a recording device to be associated with said second window and controlled through said user interface.

44. The processor-readable instructions of claim 43, wherein said user interface further comprises a device identifier for identifying which connected recording device is currently associated with said second window.

45. The processor-readable instructions of claim 37, wherein when multiple source of audiovisual programming are connected to said video display device, said user interface further comprises an identifier identifying which source of audiovisual programming is associated with said first window.

46. The processor-readable instructions of claim 45, wherein said user interface further comprises controls associated with said first window for selecting and controlling said source of audiovisual programming associated with said first window.

47. The processor-readable instructions of claim 46, wherein said user interface further comprises a status identifier identifying a current operation being performed by said source of audiovisual programming associated with said first window.

48. The processor-readable instructions of claim 36, wherein said first window displays an electronic program guide for said source of audiovisual programming associated with said first window, and said second window lists programs selected by a user from said electronic program guide.

49. The processor-readable instructions of claim 48, wherein said user interface causes said recording device associated with said second window to record said programs selected by a user from said electronic program guide.

50. The processor-readable instructions of claim 48, wherein, when multiple recording devices are available, said user interface comprises controls for selecting which recording device is associated with said second window.

51. The processor-readable instructions of claim 48, wherein, when multiple sources of audiovisual programming are available, said user interface comprises controls for selecting which source of audiovisual programming is associated with said first window.

52. A method of operating a user interface for a video display device comprising:
displaying said user interface on a screen of said video display device;
associating a first window of said user interface with a source of audiovisual programming; and
associating a second window with a connected recording device.

53. The method of claim 52, displaying said audiovisual programming from said source of audiovisual programming in said first window.

54. The method of claim 52, wherein said connected recording device is also a second source of audiovisual programming, and said method comprises displaying audiovisual programming from said recording device in said second window.

55. The method of claim 52, further comprising controlling said connected recording device with on-screen controls of said user interface.

56. The method of claim 55, further comprising displaying a status identifier for identifying a current operation being performed by said connected recording device.

57. The method of claim 55, further comprising sending a record command to said connected recording device with said on-screen controls, wherein said connected recording device then automatically records said audiovisual programming being displayed in said first window.

58. The method of claim 57, further comprising displaying said audiovisual programming in said second window while said connected recording device is recording that audiovisual programming.

59. The method of claim 55, further comprising, when multiple recording device are available, using said on-screen controls for selecting a recording device to be associated with said second window and controlled through said user interface.

60. The method of claim 59, further comprising displaying a device identifier for identifying which connected recording device is currently associated with said second window.

61. The method of claim 52, further comprising displaying an identifier identifying said source of audiovisual programming, with multiple sources of audiovisual programming being available.

62. The method of claim 61, further comprising selecting and controlling said source of audiovisual programming associated with said first window with controls associated with said first window.

63. The method of claim 62, further comprising displaying a status identifier identifying a current operation being performed by said source of audiovisual programming.

64. The method of claim 52, further comprising:
displaying in said first window an electronic program guide for said source of audiovisual programming associated with said first window; and
displaying in said second window a list of programs selected by a user from said electronic program guide.

65. The method of claim 64, further comprising automatically recording said programs selected by a user from said electronic program guide with the connected recording device associated with said second window.

66. The method of claim 64, wherein multiple recording devices are available, said method further comprising selecting which recording device is associated with said second window using controls of said user interface.

67. The method of claim 64, wherein multiple sources of audiovisual programming are available, said method further comprising selecting which source of audiovisual programming is associated with said first window using controls of said user interface.

68. A user interface system for a video display device comprising:
means for displaying said user interface on a screen of said video display device;
means for associating a first window of said user interface with a source of audiovisual programming; and
means for associating a second window with a connected recording device.

69. The system of claim 68, further comprising means for displaying an electronic programming guide for said source of audiovisual programming in said first window.

70. An audiovisual device in communication with at least one recording device, said audiovisual device comprising:
a user input device; and
a user interface displayed on said audiovisual device;
wherein said user interface comprises a first window associated with a source of audiovisual programming, and a second window associated with said recording device.

71. The device of claim 70, wherein said first window displays said audiovisual programming from said source of audiovisual programming.

72. The device of claim 70, wherein said recording device is also a second source of audiovisual programming and audiovisual programming from said recording device is displayed in said second window.

73. The device of claim 70, wherein said user input device comprises a remote control unit.

74. The device of claim 70, wherein said user interface further comprises on-screen controls for controlling said recording device, said on-screen controls being operated with said user input device.

75. The device of claim 74, wherein said user interface further comprises a status identifier for identifying a current operation being performed by said recording device.

76. The device of claim 74, wherein, when said on-screen controls are used to send a record command to said recording device, said recording device automatically records audiovisual programming from said audiovisual source associated with said first window.

77. The device of claim 70, wherein said audiovisual device communicates with multiple recording devices and said user interface comprises controls for selecting a recording device to be associated with said second window and controlled through said user interface.

78. The device of claim 77, wherein said user interface further comprises a device identifier for identifying which recording device is currently associated with said second window.

79. The device of claim 70, wherein said user interface further comprises an identifier identifying said source of audiovisual programming, with multiple sources of audiovisual programming being available.

80. The device of claim 70, wherein said user interface further comprises controls associated with said first window for selecting and controlling said source of audiovisual programming associated with said first window.

81. The device of claim 70, wherein said audiovisual device communicates with said recording device through an IEEE 1394 interface.

82. The device of claim 70, wherein said audiovisual device is a computer.

83. The device of claim 70, wherein said audiovisual device is a television set.

84. The device of claim 70, further comprising a memory card accessible to said audiovisual device, wherein said memory card is said recording device associated with said second window.
